(19) United States
(12) Patent Application Publication
(10) Pub. No.: US 2010/0044443 A1
(43) Pub. Date: Feb. 25, 2010

(54) COMMUNICATION APPARATUS, COMMUNICATION METHOD, PROGRAM AND COMMUNICATION SYSTEM

(75) Inventor: Hideo Yamamoto, Tokyo (JP)

Correspondence Address: K&L Gates LLP, P. O. BOX 1135, CHICAGO, IL, 60690, US

(73) Assignee: SONY CORPORATION, Tokyo (JP)

(21) Appl. No.: 12/543,135

(22) Filed: Aug. 18, 2009

(30) Foreign Application Priority Data
Aug. 20, 2008 (JP) 2008-211997

(51) Int. Cl. G06K 19/06

(52) U.S. Cl. 235/492

(57) ABSTRACT

A communication apparatus includes: a power generation means for generating drive power to be supplied to individual sections based on an electromagnetic wave transmitted from a reader/writer; a communication means for communicating with the reader/writer in a non-contact manner; an acceleration detection means for detecting an acceleration during generation of the drive power, and converts the detected acceleration to movement information indicative of a moving direction; a storage means for storing the movement information; and a processing means for executing a process according to the moving direction indicated by the stored movement information.

### CROSS REFERENCES TO RELATED APPLICATIONS

The present application claims priority to Japanese Priority Patent Application JP 2008-211997 filed in the Japan Patent Office on Aug. 20, 2008, the entire contents of which is hereby incorporated by reference.

### BACKGROUND

The present application relates to a communication apparatus, a communication method, a program, and a communication system, and, more particularly, to a communication apparatus, a communication method, a program, and a communication system which are suitable for use, for example, in a case where the top side and bottom side of a non-contact communication IC card are provided with different functions.

There are information cards typified by a cash card or a credit card, each of which has multiple functions (e.g., the function of a cash card and the function of a credit card), not a single function (e.g., the function of a cash card).

FIG. 1 shows the basic structure of a magnetic type information card having multiple functions. This information card 1 is provided with a magnetic band 2-1 and a magnetic band 2-2 along opposite long sides, respectively.

One magnetic band 2-1 has information for a function A (e.g., the function of a cash card) recorded therein. The other magnetic band 2-2 has information for a function B (e.g., the function of a credit card) recorded therein.

In using the information card 1, as a user loads the information card 1, facing in a direction A, into the reader of a cash dispenser or the like, for example, the function A of the information card 1 is enabled, while as the user loads the information card 1, facing in a direction B, into the reader of the cash dispenser, for example, the function B of the information card 1 is enabled.

Information cards having multiple functions include an IC embedded card having an IC chip embedded therein in addition to the foregoing magnetic type card.

In using the IC embedded card, as a user loads the IC embedded card, facing in an arbitrary direction, into the reader of a cash dispenser or the like, the reader identifies the multiple functions of the IC embedded card (e.g., the function of a cash card and the function of a credit card). Then, the reader allows the user to select a desired one of the multiple functions of the IC embedded card.

Nowadays, a non-contact communication IC card typified by FeliCa (Trademark) is popular, and this non-contact communication IC card, like the foregoing information card and IC embedded card, can be provided with multiple functions.

It is to be noted however that as in the case of the IC embedded card, a reader/writer allows the user to select a desired one of the multiple functions of the non-contact communication IC card.

An acceleration sensor provided in a portable terminal incorporating an IC chip equivalent to a non-contact communication IC card has been provided (e.g., see Patent Document 1 (JP-A-2008-148102)). However, the invention disclosed in Patent Document 1 merely detects if, of the outer sides of a portable terminal, the side which is provided with an antenna for the IC chip is properly placed close to the reader/writer, and warns the user of improper approach of the portable terminal

### SUMMARY

In a case where an existing non-contact communication IC card is provided with multiple functions as mentioned above, a user needs to perform an operation of placing the non-contact communication IC card closer to the reader/writer and an operation of selecting one of the multiple functions presented by the reader/writer.

Of the two operations, the one to place the non-contact communication IC card closer to the reader/writer is inevitable, so that the convenience for the user is improved if the operation of selecting one of the multiple functions presented by the reader/writer can be omitted.

That is, in a case where the non-contact communication IC card is provided with two functions A and B, for example, it is desirable to provide a technique which enables the function A when the top side of the non-contact communication IC card is placed closer to the reader/writer, and enables the function B when the bottom side of the non-contact communication IC card is placed closer to the reader/writer.

Further, the non-contact communication IC card needs to take a countermeasure against skimming (information theft) which is carried out by illegitimately using the feature of the non-contact communication capability.

The present application addresses the above situations to improve the convenience for a user who uses a non-contact communication IC card.

A first aspect of the present application is directed to a communication apparatus including a power generation means for generating drive power to be supplied to individual sections based on an electromagnetic wave transmitted from a reader/writer, a communication means for communicating with the reader/writer in a non-contact manner, an acceleration detection means for detecting an acceleration during generation of the drive power, and converts the detected acceleration to movement information indicative of a moving direction, a storage means for storing the movement information, and a processing means for executing a process according to the moving direction indicated by the stored movement information.

The processing means can determine a top side or bottom side of the communication apparatus according to the moving direction indicated by the stored movement information when the communication apparatus is placed closer to the reader/writer, and execute different processes based on a determination result.

In a case where the processing means cannot determine the top side or bottom side of the communication apparatus according to the moving direction indicated by the stored movement information when the communication apparatus is placed closer to the reader/writer, the processing means can determine the top side or bottom side of the communication apparatus again according to a moving direction indicated by latest movement information when the communication apparatus is placed closer to the reader/writer, and execute different processes based on a determination result.

In a case where the processing means cannot determine the top side or bottom side of the communication apparatus according to the moving direction indicated by the stored movement information when the communication apparatus is placed closer to the reader/writer, the processing means can execute a process corresponding to a predetermined one of the top side and the bottom side.

The processing means can execute different processes according to a time-sequential change in the moving direction indicated by the stored movement information.

The first aspect of the present application is also directed to a communication method for a communication apparatus that communicates with a reader/writer in a non-contact manner, including the steps of generating drive power to be supplied to individual sections based on an electromagnetic wave transmitted from the reader/writer, detecting an acceleration during generation of the drive power, converting the detected acceleration to movement information indicative of a moving direction, storing the movement information, and executing a process according to the moving direction indicated by the stored movement information.

The first aspect of the present application is also directed to a program for controlling a communication apparatus that communicates with a reader/writer in a non-contact manner, the program allowing a computer of the communication apparatus to execute a process including the steps of generating drive power to be supplied to individual sections based on an electromagnetic wave transmitted from the reader/writer, detecting an acceleration during generation of the drive power, converting the detected acceleration to movement information indicative of a moving direction, storing the movement information, and executing a process according to the moving direction indicated by the stored movement information.

According to the first aspect of the present application, drive power to be supplied to individual sections is generated based on an electromagnetic wave transmitted from the reader/writer, an acceleration is detected during generation of the drive power, the detected acceleration is converted to movement information indicative of a moving direction, the movement information is stored, and a process according to the moving direction indicated by the stored movement information is executed.

A second aspect of the present application is directed to a communication system for carrying out non-contact communication between a communication apparatus and a reader/writer, wherein the communication apparatus includes a power generation means for generating drive power to be supplied to individual sections based on an electromagnetic wave transmitted from a reader/writer, a communication means for communicating with the reader/writer in a non-contact manner, an acceleration detection means for detecting an acceleration during generation of the drive power, and converts the detected acceleration to movement information indicative of a moving direction, a storage means for storing the movement information, and a processing means for executing a process according to the moving direction indicated by the stored movement information, and wherein the reader/writer includes a transmission means for transmitting a command to the communication apparatus, and a reception means for receiving a response from the communication apparatus.

According to the second aspect of the present application, the communication apparatus generates drive power to be supplied to individual sections based on an electromagnetic wave transmitted from the reader/writer, detects an acceleration during generation of the drive power, converts the detected acceleration to movement information indicative of a moving direction, stores the movement information, and executes a process according to the moving direction indicated by the stored movement information.

According to the first aspect of the present application, it is possible to detect the direction of the communication apparatus when the communication apparatus is placed closer to the reader/writer.

According to the first aspect of the present application, it is possible to automatically select a function of the communication apparatus according to the direction of the communication apparatus when the communication apparatus is placed closer to the reader/writer. This can improve the convenience for a user.

According to the second aspect of the present application, it is possible to automatically select a function of a non-contact communication IC card to the direction of the non-contact communication IC card when the non-contact communication IC card is placed closer to the reader/writer. This can improve the convenience for a user.

Additional features and advantages are described herein, and will be apparent from the following Detailed Description and the figures.

### BRIEF DESCRIPTION OF THE FIGURES

FIG. 1 is a diagram showing a magnetic type information card having multiple functions;

FIG. 2 is a block diagram showing an example of the structure of a non-contact communication IC card to which the present application is adapted;

FIG. 3 is a diagram illustrating a moving direction to be detected by an acceleration sensor shown in FIG. 2;

FIG. 4 is a diagram showing the relationship between a non-contact communication IC card and the communication area of a reader/writer;

FIG. 5 is a flowchart illustrating a moving direction recording process;

FIG. 6 is a flowchart illustrating a first activation process;

FIG. 7 is a flowchart illustrating a second activation process;

FIG. 8 is a flowchart illustrating a third activation process; and

FIG. 9 is a diagram showing one example of a gesture automaton decision.

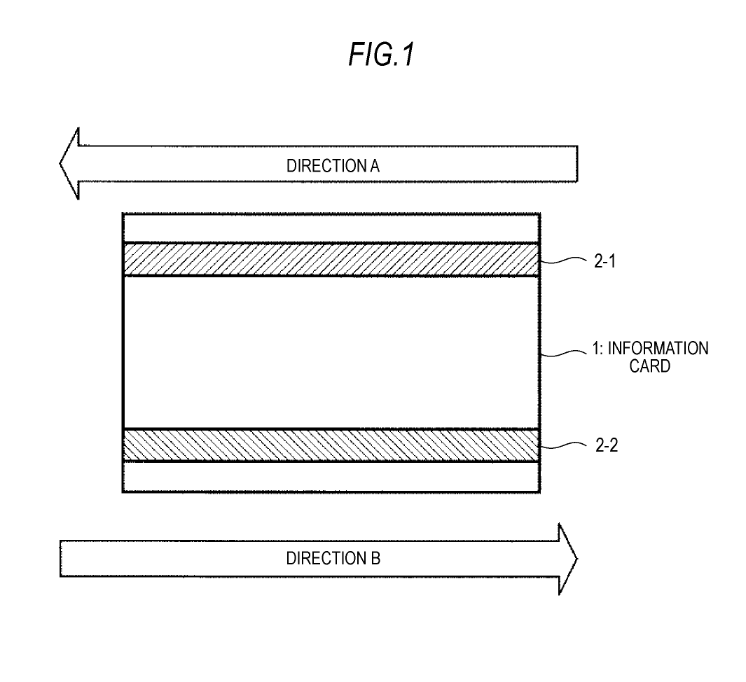

### DETAILED DESCRIPTION

The present application described below with reference to the accompanying drawings.

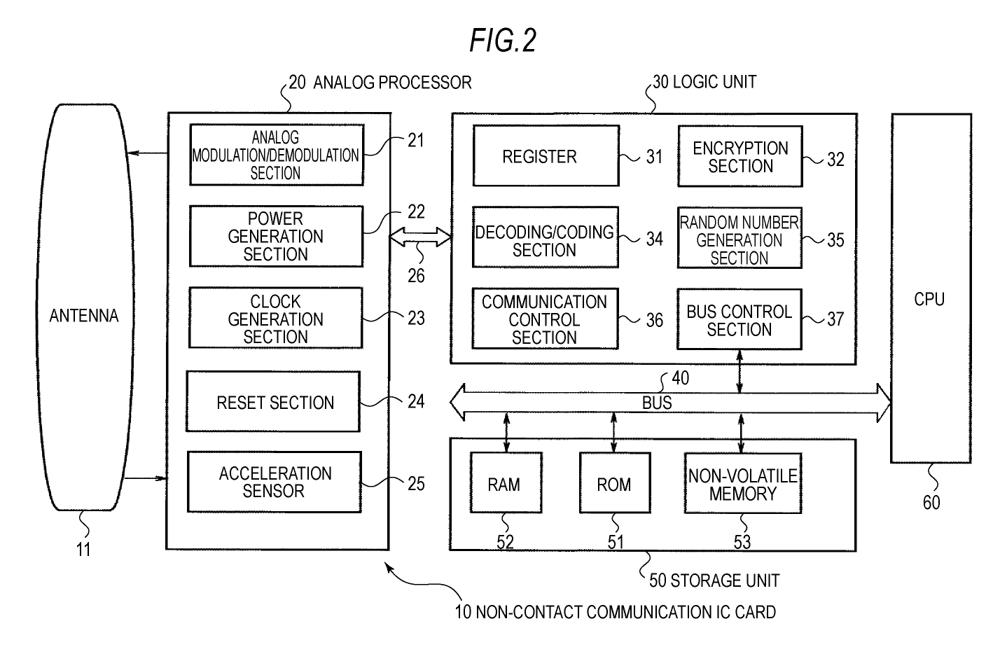

FIG. 2 shows an example of the structure of a non-contact communication IC card according to one embodiment.

This non-contact communication IC card 10 mainly includes an antenna 11, an analog processor 20, a logic unit 30, a storage unit 50, and a CPU 60.

The antenna 11 performs data communication with a reader/writer (hereinafter called R/W) 70 (FIG. 4) using an electromagnetic wave.

The analog processor 20 includes an analog modulation/demodulation section 21, a power generation section 22, a clock generation section 23, a reset section 24, and an acceleration sensor 25.

The analog modulation/demodulation section 21 demodulates an electromagnetic wave received by the antenna 11 to yield a demodulated signal, and outputs the demodulated signal to the logic unit 30 via an input/output interface 26. The analog modulation/demodulation section 21 also modulates a coded signal (response) input from the logic unit 30 via the input/output interface 26.

The power generation section 22 generates drive power for the non-contact communication IC card 10 based on the electromagnetic wave from the R/W 70. The clock generation section 23 generates a clock signal for synchronize the operations of the individual sections of the non-contact communication IC card 10. The reset section 24 generates a reset signal which triggers the initialization to be carried out by the CPU 60.

The acceleration sensor 25 detects an acceleration which is generated by a user's operation of, for example, placing the non-contact communication IC card 10 closer to the R/W 70, converts the acceleration to information indicative of the direction thereof, and outputs the information to the logic unit 30 via the input/output interface 26.

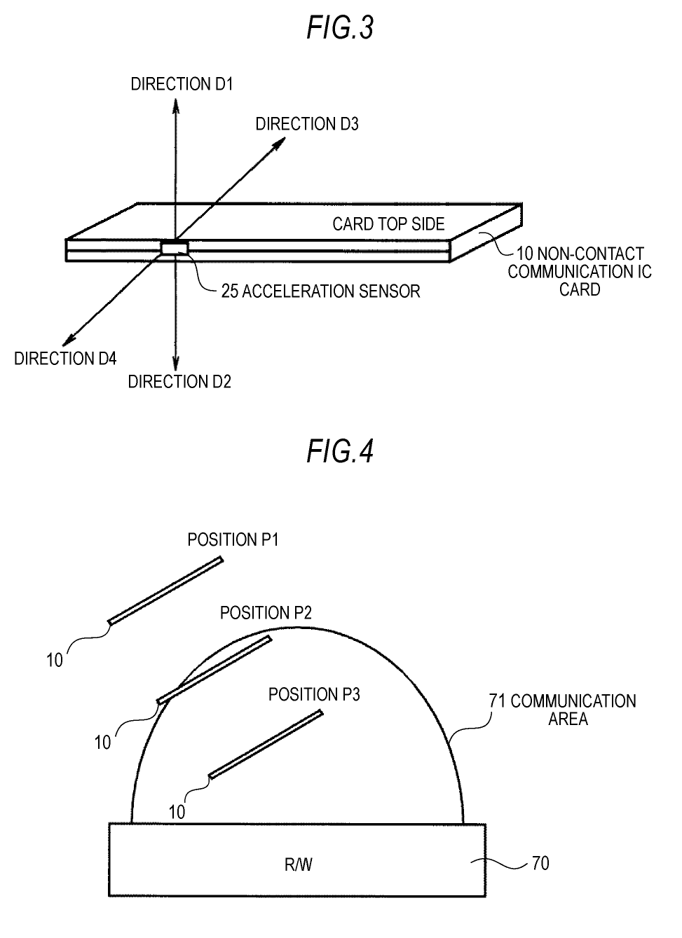

Specifically, as shown in FIG. 3, for example, the acceleration sensor 25 detects an acceleration applied to the non-contact communication IC card 10, converts the detection result to information indicative of a direction D1, D2, D3 or D4 of the non-contact communication IC card 10, or stillness thereof, and outputs the information to the logic unit 30 via the input/output interface 26.

In FIG. 3, the directions D1 and D2 are perpendicular to the top side of the non-contact communication IC card 10; for example, the direction D1 is detected when the top side of the non-contact communication IC card 10 is moved toward the R/W 70, whereas the direction D2 is detected when the bottom side of the non-contact communication IC card 10 is moved toward the R/W 70.

The directions D3 and D4 are parallel to the top side and the short side of the non-contact communication IC card 10, and are detected, for example, when the non-contact communication IC card 10 is shaken in parallel to that side of the non-contact communication IC card 10.

Although the acceleration sensor 25 is illustrated to detect four directions D1 to D4 in the example of FIG. 3, it may be configured to detect, for example, only two directions D1 and D2. Alternatively, the acceleration sensor 25 may be configured to detect a greater number of directions, e.g., six directions including directions parallel to the top side and long side of the non-contact communication IC card 10.

The logic unit 30 includes a register 31, an encryption section 32, a decoding/coding section 34, a random number generation section 35, a communication control section 36, and a bus control section 37.

The register 31 stores information (information indicative of the moving direction or stillness of the non-contact communication IC card 10) from the acceleration sensor 25. Referring to the information stored in the register 31, it is possible to determine, for example, whether the side of the non-contact communication IC card 10 when placed closer to the R/W 70 is the top side or the bottom side.

The encryption section 32 performs encryption of information to be stored in a non-volatile memory 53. The decoding/coding section 34 decodes the demodulated signal from the analog modulation/demodulation section 21, and outputs a command resulting from the decoding to the CPU 60 via a bus 40. The decoding/coding section 34 codes a response generated by the CPU 60, and outputs a coded signal resulting from the coding to the analog modulation/demodulation section 21 via the input/output interface 26. The random number generation section 35 generates a random number to be used in encryption which is carried out by the encryption section 32.

The communication control section 36 controls communication with the R/W 70. The bus control section 37 controls the bus 40 for communication among the logic unit 30, the storage unit 50 and the CPU 60.

The storage unit 50 includes an ROM 51 storing an OS (Operation System) to be executed by the CPU 60, and various application programs, an RAM 52 to be used as a work area for the CPU 60, and the non-volatile memory 53 including an EEPROM or the like to temporarily or permanently store data.

FIG. 4 shows the positional relationship between the non-contact communication IC card 10 and the R/W 70.

When the user places the non-contact communication IC card 10 closer to the R/W 70, the position of the non-contact communication IC card 10 changes in the order of P1, P2 and P3.

At the position P1 where the non-contact communication IC card 10 is not in a communication area 71, drive power is not generated in the non-contact communication IC card 10. Therefore, the non-contact communication IC card 10 including the acceleration sensor 25 does not operate at all.

When the non-contact communication IC card 10 comes to the position P2 or the position P3 in the communication area 71, drive power is generated in the non-contact communication IC card 10. The drive power causes the individual sections of the non-contact communication IC card 10 including the acceleration sensor 25 to start operating.

Next, the operation of the non-contact communication IC card 10 is described specifically.

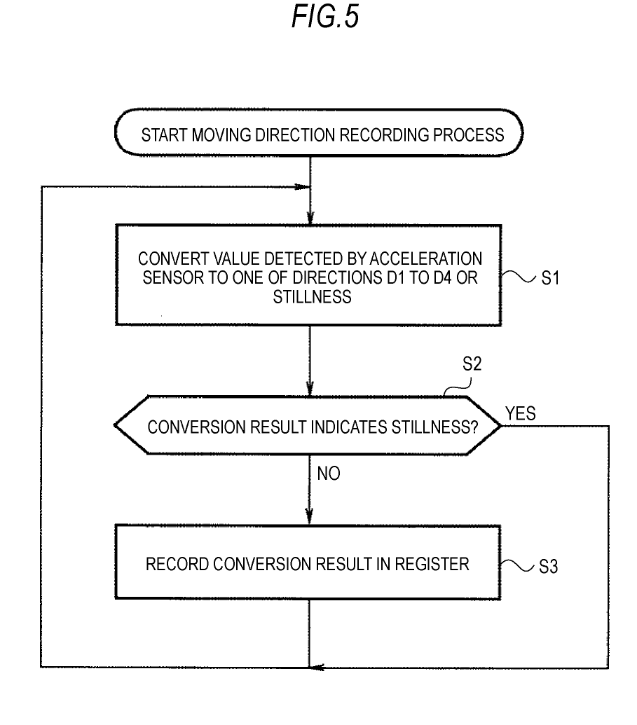

First, a moving direction recording process which is initiated before activation of the non-contact communication IC card 10 is described referring to a flowchart in FIG. 5.

The moving direction recording process is initiated when the power generation section 22 generates drive power as a result of the non-contact communication IC card 10 being placed closer the R/W 70 and entering the communication area 71, and the clock generation section 23 generates a clock signal. The moving direction recording process is repeatedly executed until the non-contact communication IC card 10 leaves the communication area 71, stopping the supply of the drive power.

In step S1, the acceleration sensor 25 detects an acceleration applied to the non-contact communication IC card 10, converts the detection result to information indicative of the direction D1, D2, D3 or D4 of the non-contact communication IC card 10, or stillness thereof, and outputs the information to the logic unit 30 via the input/output interface 26.

In step S2, the register 31 of the logic unit 30 determines whether the information from the acceleration sensor 25 indicates stillness or not. When determining that the information does not indicate stillness, the process proceeds to step S3 to store the information indicative of the moving direction D1, D2, D3 or D4. Then, the process returns to step SI to resume the sequence of processes at and following step S1 are executed.

When it is determined in step S2 that the information from the acceleration sensor 25 indicates stillness, step 3 is skipped, and the process returns to step S1 to resume the sequence of processes at and following step S1.

According to the moving direction recording process, as described above, information indicative of the moving direction of the non-contact communication IC card 10 can be stored in the register 31. Even when the non-contact communication IC card 10 is set still, information indicative of the moving direction of the non-contact communication IC card 10 before being set still can be stored in the register 31. Based on the information stored in the register 31, therefore, it is possible to determine, for example, which side of the non-contact communication IC card 10, the top side or the bottom side, is placed closer to the R/W 70.

Next, three kinds of activation processes which are executed in parallel to the moving direction recording process are described.

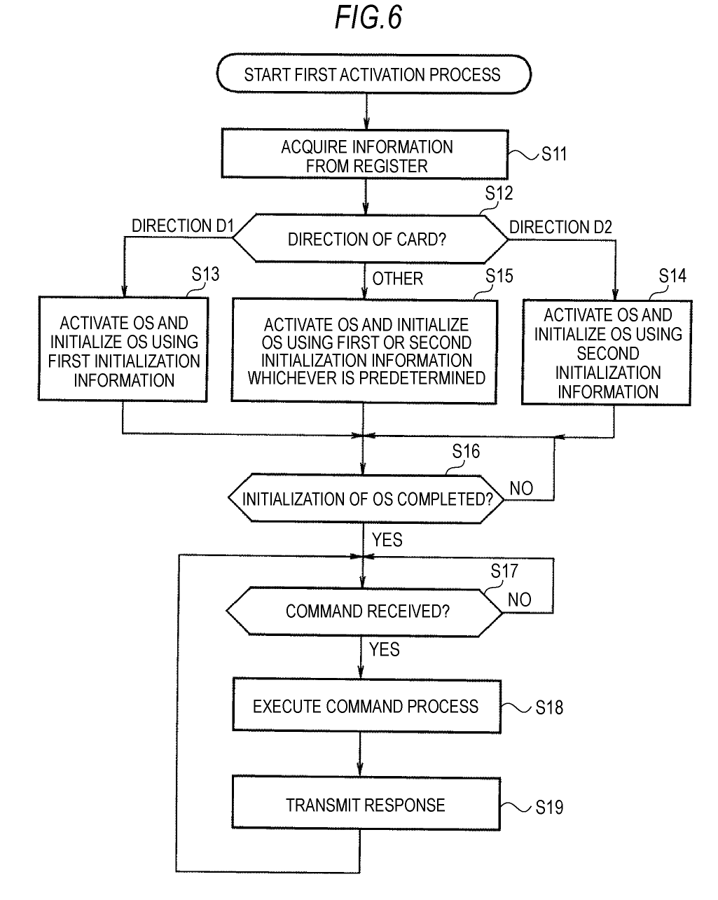

FIG. 6 is a flowchart illustrating a first activation process.

The first activation process is initiated when the power generation section 22 generates drive power as a result of the non-contact communication IC card 10 being placed closer to the R/W 70 and entering the communication area 71, the clock generation section 23 generates a clock signal, the reset section 24 generates a reset signal and the reset signal is input to the CPU 60.

In step S11, the CPU 60 acquires information stored in the register 31. In step S12, based on the information acquired in step S11, the CPU 60 determines whether the moving direction of the non-contact communication IC card 10 is the direction D1, or the direction D2, or other than the directions D1 and D2.

When it is determined in step S12 that the moving direction of the non-contact communication IC card 10 is the direction D1 (when the top side of the non-contact communication IC card 10 is placed closer to the R/W 70), the process proceeds to step S13. In step S13, the CPU 60 loads the OS stored in the ROM 51 into the RAM 52 and activates the OS, and then initializes the activated OS using first initialization information stored in the ROM 51. Then, the process goes to step S 16.

When it is determined in step S12 that the moving direction of the non-contact communication IC card 10 is the direction D2 (when the bottom side of the non-contact communication IC card 10 is placed closer to the R/W 70), however, the process proceeds to step S14. In step S14, the CPU 60 loads the OS stored in the ROM 51 into the RAM 52 and activates the OS, and then initializes the activated OS using second initialization information stored in the ROM 51. Then, the process goes to step S16.

When it is determined in step S12 that the moving direction of the non-contact communication IC card 10 is other than the directions D1 and D2, the process proceeds to step S15. In step S15, the CPU 60 loads the OS stored in the ROM 51 into the RAM 52 and activates the OS, and then initializes the activated OS using the first initialization information or the second initialization information stored in the ROM 51, whichever is predetermined. Then, the process goes to step S16. The OS may not be activated in step S15 and the process may be returned to step S11 to resume the sequence of processes at and following step S11.

In step S16, the CPU 60 stands by until the initialization of the OS which is initiated in step S13, S14 or S15 is completed. When the initialization of the OS is completed, the process proceeds to step S17.

In step S17, the OS which is activated and initialized by the CPU 60 stands by until it receives a command transmitted from the R/W 70. When the command transmitted from the R/W 70 is received, the process proceeds to step S18.

In step S18, the OS executes a command process corresponding to the received command to generate a response including the result of the command process. In step S19, the OS codes and modulates the response generated in step S18, and transmits the resultant response from the antenna 11. Thereafter, the processes of steps S17 to S19 are repeated until the non-contact communication IC card 10 leaves the communication area 71, stopping the supply of the drive power.

As described above, the use of the first activation process can allow information to be used in initializing the OS to be changed from one to another between when the top side of the non-contact communication IC card 10 is placed closer to the R/W 70 and when the bottom side of the non-contact communication IC card 10 is placed closer to the R/W 70.

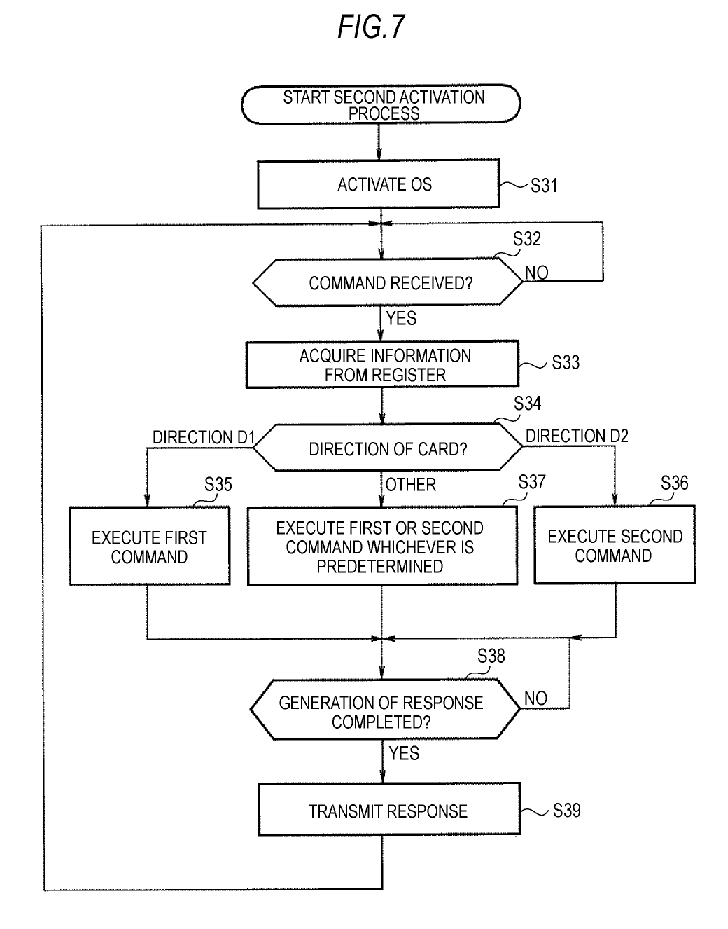

FIG. 7 is a flowchart illustrating a second activation process.

The second activation process is initiated when the power generation section 22 generates drive power as a result of the non-contact communication IC card 10 being placed closer to the R/W 70 and entering the communication area 71, the clock generation section 23 generates a clock signal, the reset section 24 generates a reset signal and the reset signal is input to the CPU 60.

In step S31, the CPU 60 loads the OS stored in the ROM 51 into the RAM 52 and activates the OS. In step S32, the OS which has completed the activation stands by until it receives a command transmitted from the R/W 70. When the command transmitted from the R/W 70 is received, the process proceeds to step S33.

In step S33, the CPU 60 acquires information stored in the register 31. In step S34, based on the information acquired in step S33, the OS determines whether the moving direction of the non-contact communication IC card 10 is the direction D1, or the direction D2, or neither one of the directions D1 and D2.

When it is determined in step S34 that the moving direction of the non-contact communication IC card 10 is the direction D1 (when the top side of the non-contact communication IC card 10 is placed closer to the R/W 70), the process proceeds to step S35. In step S35, the OS executes a predetermined first command process corresponding to the received command to generate a response including the result of the first command process. Thereafter, the process proceeds to step S38.

When it is determined in step S34 that the moving direction of the non-contact communication IC card 10 is the direction D2 (when the bottom side of the non-contact communication IC card 10 is placed closer to the R/W 70), however, the process proceeds to step S36. In step S36, the OS executes a predetermined second command process corresponding to the received command to generate a response including the result of the second command process. Thereafter, the process proceeds to step S38.

When it is determined in step S34 that the moving direction of the non-contact communication IC card 10 is neither the direction D1 nor the direction D2, the process proceeds to step S37. In step S37, the OS executes the predetermined first command process or the predetermined second command process, whichever is predetermined, to generate a response including the result of the command process. Thereafter, the process proceeds to step S38. Neither one of the first and second command processes may be executed in step S37, and the process may be returned to step S33 to resume the sequence of processes at and following step S33.

In step S38, the OS stands by until the generation of a response indicative of the result of the command process executed in step S37 is completed. When the generation of the response is completed, the process proceeds to step S39.

In step S39, the OS codes and modulates the generated response, and transmits the resultant response from the antenna 11. Thereafter, the processes of steps S32 to S39 are repeated until the non-contact communication IC card 10 leaves the communication area 71, stopping the supply of the drive power.

As described above, the second activation process can permit switching of the command process corresponding to a command transmitted from the R/W 70 between when the top side of the non-contact communication IC card 10 is placed closer to the R/W 70 and when the bottom side of the non-contact communication IC card 10 is placed closer to the R/W 70.

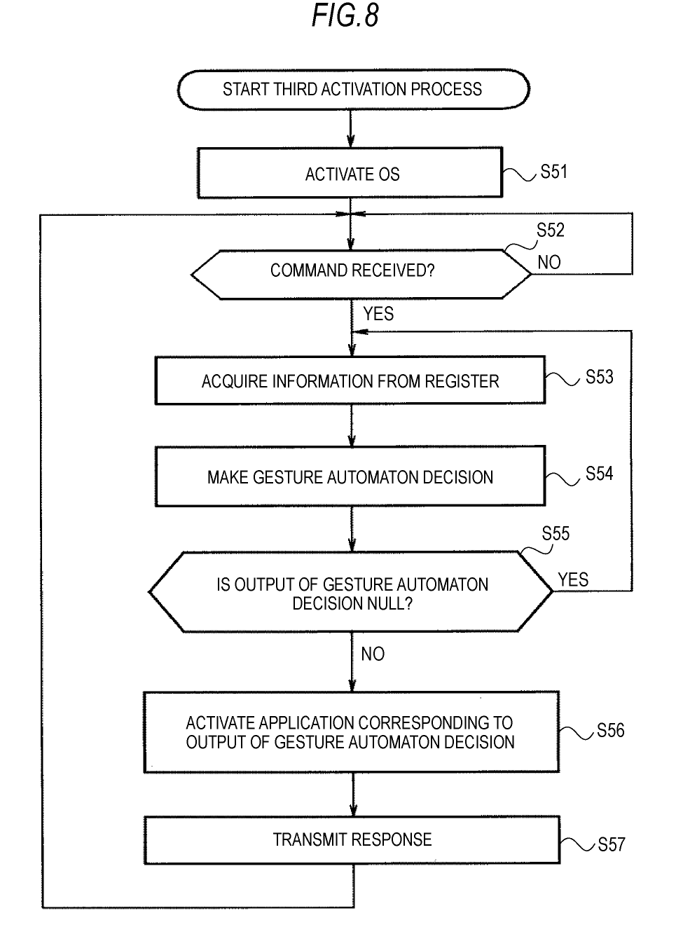

FIG. 8 is a flowchart illustrating a third activation process.

The third activation process is initiated when the power generation section 22 generates drive power as a result of the non-contact communication IC card 10 being placed closer to the R/W 70 and entering the communication area 71, the clock generation section 23 generates a clock signal, the reset section 24 generates a reset signal and the reset signal is input to the CPU 60.

In step S51, the CPU 60 loads the OS stored in the ROM 51 into the RAM 52 and activates the OS. In step S52, the OS which has completed the activation stands by until it receives a command transmitted from the R/W 70. When the command transmitted from the R/W 70 is received, the process proceeds to step S53.

In step S53, the CPU 60 acquires information stored in the register 31. In step S54, based on the information acquired from the register 31, the OS makes gesture automaton decision.

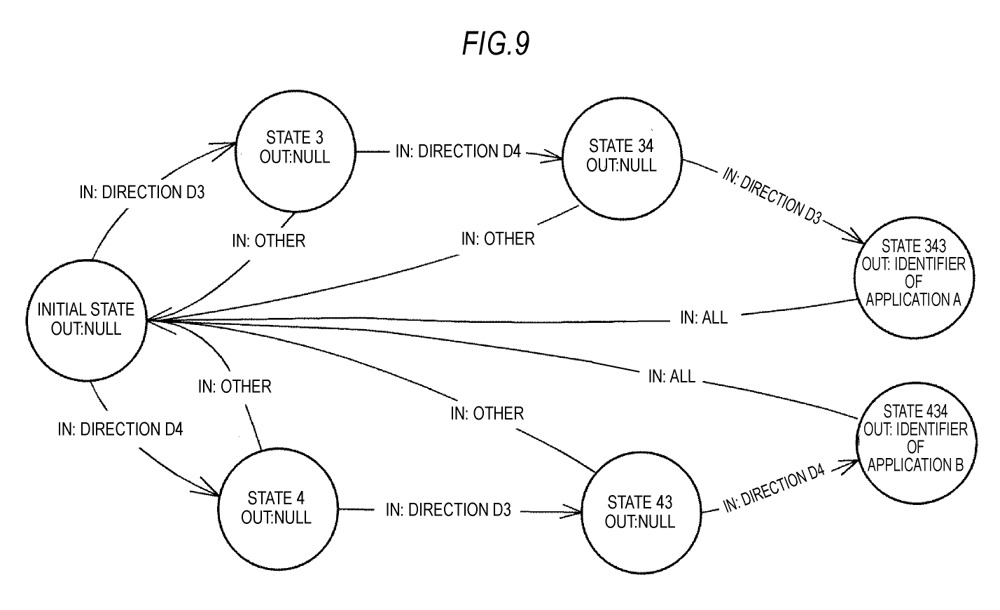

For example, the gesture automaton decision is to provide an output according to the present state with information acquired from the register 31 being an input, and to shift the state to a next state as shown in FIG. 9; NULL or the identifier of an application is output from each state.

In the example shown in FIG. 9, when the input (information acquired from the register 31) is the direction D3 in the initial state, for example, NULL is output and the state is shifted to a state 3. When the input is the direction D4 in the state 3, NULL is output and the state is shifted to a state 34. Further, when the input is the direction D3 in the state 34, the identifier of an application A is output and the state is shifted to a state 343. In the state 343, NULL is output for every input and the state is shifted to the initial state.

When the input is the direction D4 in the initial state, for example, NULL is output and the state is shifted to a state 4. When the input is the direction D3 in the state 4, NULL is output and the state is shifted to a state 43. Further, when the input is the direction D4 in the state 43, the identifier of an application B is output and the state is shifted to the state 34.

That is, to activate the application A, the user needs to move the non-contact communication IC card 10 in the order of the directions D3, D4 and D3. To activate the application B, the user needs to move the non-contact communication IC card 10 in the order of the directions D4, D3 and D4.

In step S55, the OS determines whether the output of the gesture automaton decision in step S54 is NULL or not. When the output is NULL, the OS returns the process to step S53 to resume the sequence of processes at and following step S53.

When it is not determined in step S55 that the output of the gesture automaton decision in step S54 is NULL, the process proceeds to step S56. In step S56, the OS invokes an application program according to the output of the gesture automaton decision in step S54 (the identifier of the application A or the identifier of the application B in the example of FIG. 9) from the ROM 51, and activates the application program.

In step S57, the application activated in step S56 executes a command process corresponding to a command received in step S52 to generate a response including the result of the command process. Then, the OS codes and modulates the generated response, and transmits the resultant response from the antenna 11. Thereafter, the processes of steps S52 to S57 are repeated until the non-contact communication IC card 10 leaves the communication area 71, stopping the supply of the drive power.

The third activation process described above can allow a desired process to be executed only when the non-contact communication IC card 10 is moved in a predetermined order and predetermined directions.

The gesture automaton decision may be provided at the R/W, so that the non-contact communication IC card 10 transmits the moving direction at any time.

The foregoing first to third activation processes can be adapted to the following illustrative cases.

For example, the first activation process can be adapted to a case where the key length of the encryption system to be used between the non-contact communication IC card 10 and the R/W 70 needs to be changed to the key length of 128 bits in future from the present block encryption system with the key length of 64 bits.

That is, when the top side of the non-contact communication IC card 10 is placed closer to the R/W 70, the OS is initialized using initialization information corresponding to the 64-bit key length, whereas when the bottom side of the non-contact communication IC card 10 is placed closer to the R/W 70, the OS is initialized using initialization information corresponding to the 128-bit key length.

This can make a single non-contact communication IC card 10 compatible with a new key length and an old key length in the transitional period of the key length of the encryption system.

In addition, the first activation process can be adapted to a case where two different electronic funds transfer applications are installed in the non-contact communication IC card 10.

That is, when the top side of the non-contact communication IC card 10 is placed closer to the R/W 70, the OS is initialized using initialization information corresponding to the first electronic funds transfer application, whereas when the bottom side of the non-contact communication IC card 10 is placed closer to the R/W 70, the OS is initialized using initialization information corresponding to the second electronic funds transfer application.

Changing the initialization information according to the top side or bottom side of the non-contact communication IC card 10 this way can prevent information on one of the first and second electronic funds transfer applications from being read from the other one.

The non-contact communication IC card 10 even with the first and second electronic funds transfer applications installed therein may be made to be identified by the R/W 70 as having only one electronic funds transfer application installed.

Therefore, the user can selectively use the first and second electronic funds transfer applications merely by being aware of the side of the non-contact communication IC card 10 placed closer to the R/W 70.

Further, the second activation process can be adapted to a case where the non-contact communication IC card 10 is used as a point card. That is, with various kinds of personal information of a user (ID number, name, sex, birthday, address, telephone number, mail address, etc.) stored in the non-volatile memory 53 of the non-contact communication IC card 10, the amount of the personal information to be notified to the R/W 70 can be selected according to the side of the non-contact communication IC card 10 placed closer to the R/W 70. Meanwhile, the point provider provides the user with different points and different benefits according to the degree of disclosure of the personal information.

Furthermore, the third activation process can be adapted as, for example, a countermeasure against skimming of the non-contact communication IC card 10.

That is, the non-contact communication IC card 10 can be made not to execute an application only when the non-contact communication IC card 10 is shaken by a predetermined number of times in a predetermined direction. This can inhibit the non-contact communication IC card 10 placed in a user's pocket or so from being skimmed.

In addition, the present application can be adapted to, for example, a case of realizing a system where the R/W 70 keeps transmitting a payment command of a predetermined unit money (e.g., 10 yen) and the unit money is being paid only while the user is shaking the non-contact communication IC card 10, placed closer to the R/W 70, horizontally.

The present application is not limited to an application to a non-contact communication IC card as in the embodiment, but can be adapted to any electronic device, such as a cellular phone, a portable player, or PDA (Personal Digital Assistant), which has functions similar to those of a non-contact communication IC card.

The sequence of processes described above can be carried out by hardware as well as by software. In case of executing the sequence of processes by software, a program which achieves the software is installed, from a program recording medium, into a computer installed in dedicated hardware, or into a general-purpose computer or the like which can execute various functions as various corresponding programs are installed therein.

The program which is executed by such a computer may be a program whose processes are executed time-sequentially in the orders described herein, or programs which are executed in parallel or at necessary timings such as the points at which they are invoked.

Further, the program may be executed by a single computer, or may be executed by a plurality of computers in a distributed manner. Furthermore, the program may be transferred to a remote computer to be executed.

In the present specification, “system” represents the overall apparatus that includes a plurality of devices.

The embodiment of the present application is not limited to the foregoing embodiment, and can be modified in various ways without departing from the spirit or scope of the application.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The application is claimed as follows:

1. A communication apparatus comprising:
a power generation means for generating drive power to be supplied to individual sections based on an electromagnetic wave transmitted from a reader/writer;
a communication means for communicating with the reader/writer in a non-contact manner;
an acceleration detection means for detecting an acceleration during generation of the drive power, and converts the detected acceleration to movement information indicative of a moving direction;
a storage means for storing the movement information; and
a processing means for executing a process according to the moving direction indicated by the stored movement information.

2. The communication apparatus according to claim 1, wherein the processing means determines a top side or bottom side of the communication apparatus according to the moving direction indicated by the stored movement information when the communication apparatus is placed closer to the reader/writer, and executes different processes based on a determination result.

3. The communication apparatus according to claim 2, wherein in a case where the processing means cannot determine the top side or bottom side of the communication apparatus according to the moving direction indicated by the stored movement information when the communication apparatus is placed closer to the reader/writer, the processing means determines the top side or bottom side of the communication apparatus again according to a moving direction indicated by latest movement information when the communication apparatus is placed closer to the reader/writer, and executes different processes based on a determination result.

4. The communication apparatus according to claim 2, wherein in a case where the processing means cannot determine the top side or bottom side of the communication apparatus according to the moving direction indicated by the stored movement information when the communication apparatus is placed closer to the reader/writer, the processing means executes a process corresponding to a predetermined one of the top side and the bottom side.

5. The communication apparatus according to claim 1, wherein the processing means executes different processes according to a time-sequential change in the moving direction indicated by the stored movement information.

6. A communication method for a communication apparatus that communicates with a reader/writer in a non-contact manner, comprising the steps of:
generating drive power to be supplied to individual sections based on an electromagnetic wave transmitted from the reader/writer;
detecting an acceleration during generation of the drive power;
converting the detected acceleration to movement information indicative of a moving direction;
storing the movement information; and
executing a process according to the moving direction indicated by the stored movement information.

7. A program for controlling a communication apparatus that communicates with a reader/writer in a non-contact manner, the program allowing a computer of the communication apparatus to execute a process comprising the steps of:
generating drive power to be supplied to individual sections based on an electromagnetic wave transmitted from the reader/writer;
detecting an acceleration during generation of the drive power;
converting the detected acceleration to movement information indicative of a moving direction;
storing the movement information; and
executing a process according to the moving direction indicated by the stored movement information.

8. A communication system for carrying out non-contact communication between a communication apparatus and a reader/writer, the communication apparatus comprising:
a power generation means for generating drive power to be supplied to individual sections based on an electromagnetic wave transmitted from a reader/writer;
a communication means for communicating with the reader/writer in a non-contact manner;
a acceleration detection means for detecting an acceleration during generation of the drive power, and converts the detected acceleration to movement information indicative of a moving direction;
a storage means for storing the movement information; and
a processing means for executing a process according to the moving direction indicated by the stored movement information, and
wherein the reader/writer includes
a transmission means for transmitting a command to the communication apparatus, and
a reception means for receiving a response from the communication apparatus.

9. A communication apparatus comprising:
a power generation unit configured to generate drive power to be supplied to individual sections based on an electromagnetic wave transmitted from a reader/writer;
a communication unit configured to communicate with the reader/writer in a non-contact manner;
an acceleration detection unit configured to detect an acceleration during generation of the drive power, and converts the detected acceleration to movement information indicative of a moving direction;
a storage unit configured to store the movement information; and
a processing unit configured to execute a process according to the moving direction indicated by the stored movement information.

10. A communication system for carrying out non-contact communication between a communication apparatus and a reader/writer, the communication apparatus comprising:
a power generation unit configured to generate drive power to be supplied to individual sections based on an electromagnetic wave transmitted from a reader/writer;
a communication unit configured to communicate with the reader/writer in a non-contact manner;
a acceleration detection unit configured to detect an acceleration during generation of the drive power, and converts the detected acceleration to movement information indicative of a moving direction;
a storage unit configured to store the movement information; and
a processing unit configured to execut a process according to the moving direction indicated by the stored movement information, and
wherein the reader/writer includes
a transmission unit configured to transmit a command to the communication apparatus, and
a reception unit configured to receive a response from the communication apparatus.
